(19) United States
(12) Patent Application Publication
(10) Pub. No.: US 2009/0304849 A1
(43) Pub. Date: Dec. 10, 2009

(54) Injection Mold

(75) Inventors: Chih-Yu Chen, Taipei Hsien (TW); Jian-Guang Huang, Taipei Hsien (TW); Chun-Yan Wu, Taipei Hsien (TW)

Correspondence Address: WPAT, PC;INTELLECTUAL PROPERTY ATTORNEYS, 2030 MAIN STREET, SUITE 1300, IRVINE, CA, 92614, US

(73) Assignee: CHENG UEI PRECISION INDUSTRY CO., LTD., Taipei Hsien (TW)

(21) Appl. No.: 12/133,241

(22) Filed: Jun. 4, 2008

(51) Int. Cl. B29C 45/42

(52) U.S. Cl. 425/554

(57) ABSTRACT

An injection mold includes a stationary mold section, a movable mold section and an up-down sliding side core. The movable mold section and the stationary mold section define a molding cavity capable of receiving liquefied molding material for forming an article. The sliding side core is received between the stationary mold section and the movable mold section and adjacent to the molding cavity, a side of the sliding side core defines a fixing portion for engaging and further moving upwardly the expected product out of the molding cavity. The injection mold can mold the expected product and conveniently guide the product out of the mold, the injection mold is easy to be manufactured, the cost for manufacturing the injection mold is lower.

### BACKGROUND OF THE INVENTION

1. Field of the Invention

This present invention relates to an injection mold, and more specifically to an injection mold having an up-down sliding side core adapted for forming an article with a knaggy side surface or receiving an article with a knaggy side surface for second molding.

2. The Related Art

Plastic injection molding has enjoyed enormous commercial success because of its ability to produce large numbers of objects and components quickly and at low prices.

Conventionally, plastic molding material is injected into a cavity formed in the inner of a traditional mold to form a plastic product which is required by customers. The plastic product formed in the traditional mold is pushed out of the traditional mold by a slider apparatus or a thimble, the slider apparatus or the thimble is generally arranged in the bottom of the traditional mold. The slider apparatus generally includes a sliding block and a peg, the peg is used for driving the sliding block, and the sliding block pushes the plastic product out of the traditional mold when the traditional mold is removed to an open position. The thimble is driven by an energy system arranged in the traditional mold, a top end of the thimble pushes the plastic product formed in the mold to remove the plastic product out of the mold.

Because the slider apparatus or the thimble is generally arranged in the mold, in order to opening a cavity in the mold to receive the slider apparatus or the thimble, the mold is designed to big, complex and not easy to manufacture. When the product molded in the mold is small, the volume of the mold is also small to reduce the material cost, the slider apparatus or the thimble is not easy to be arranged in the small mold to push the product out of the small mold.

### SUMMARY OF THE INVENTION

In one aspect of the present invention, an injection mold adapted for forming an article with a knaggy side surface comprises a stationary mold section, a movable mold section, an up-down sliding side core and an ejecting rod. The movable mold section is placed under the stationary mold section, the stationary and the movable mold sections define a molding cavity therebetween for forming the article. The sliding side core defines a knaggy portion in a side surface thereof, the sliding side core is slidably received between the stationary mold section and the movable mold section with the knaggy portion connecting to the molding cavity for forming the knaggy side surface of the article. The ejecting rod has an upper end secured to the sliding side core and a lower end extending downwardly through the movable mold and protruding from the movable mold for being urged upward to push the sliding side core together with the article out of the molding cavity.

In another aspect of the present invention, an injection mold adapted for receiving an article with a knaggy side surface for second molding includes a stationary mold section, a movable mold section, an up-down sliding side core received between the stationary mold section and the movable mold section and an ejecting rod. The movable mold section is placed under the stationary mold section, the stationary and the movable mold sections define a molding cavity therebetween. The sliding side core is slidably received between the stationary mold section and the movable mold section, the sliding side core defines a knaggy portion in a side surface thereof for receiving the knaggy side surface of the article. The ejecting rod has an upper end secured to the sliding side core and a lower end extending downwardly through the movable mold and protruding from the movable mold for being urged upward to push the sliding side core out of the movable mold section, whereby the sliding side core can be ejected to receive the knaggy side surface of the article first and then bring the article into the molding cavity for second molding.

As above description, the injection mold has an up-down sliding side core adapted for forming an article with a knaggy side surface or receiving an article with a knaggy side surface for second molding, and conveniently guide the article out of the injection mold, the injection mold is easy to be manufactured, the cost for manufacturing the injection mold is lower.

### BRIEF DESCRIPTION OF THE DRAWINGS

The invention, together with its objects and the advantages thereof may be best understood by reference to the following description taken in conjunction with the accompanying drawings, in which:

FIG. 1 is an exploded perspective of an injection mold according to the present invention;

FIG. 2 is a perspective of a mold unit of the injection mold;

FIG. 3 is a perspective of a stationary mold section of the mold unit;

FIG. 4 is an assembly perspective of a movable mold section and an up-down sliding side core of the mold unit;

FIG. 5 is a perspective of the movable mold section;

FIG. 6 is an exploded perspective showing the movable mold section, the sliding side core and an inserting apparatus;

FIG. 7 is an exploded perspective showing the sliding side core of the mold unit;

FIG. 8 is a cross-sectional view taken along line VIII-VIII of FIG. 2;

FIG. 9 is a cross-sectional view taken along line IX-IX of FIG. 7;

FIG. 10 is a cross-sectional view taken along line X-X of FIG. 3;

FIG. 11 is a perspective of an article which is molded in the mold unit for once molding as a first usage;

FIG. 12 is an exploded perspective of a whole article which is molded in the mold unit for second molding as a second usage;

FIG. 13 is a perspective of the whole article formed in the mold unit; and

FIG. 14 is a perspective of the whole article separated with the movable mold section.

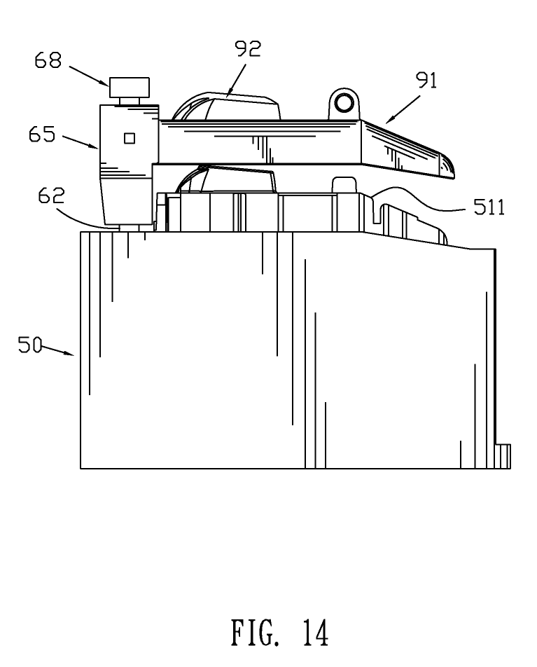

### DETAILED DESCRIPTION OF THE PREFERRED EMBODIMENT

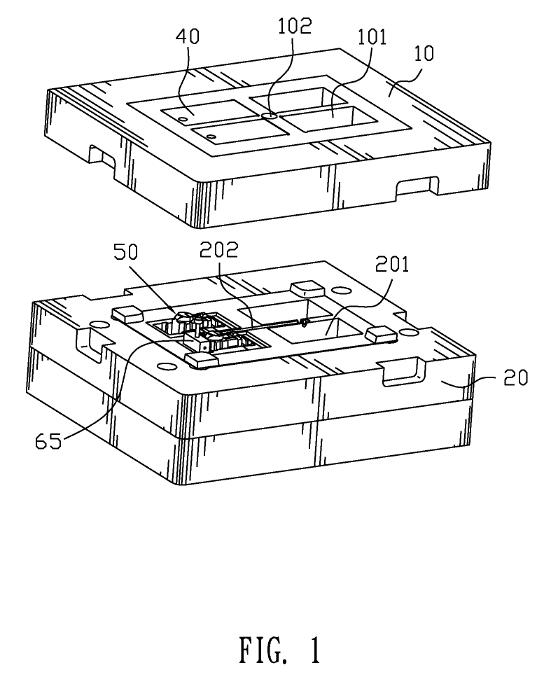

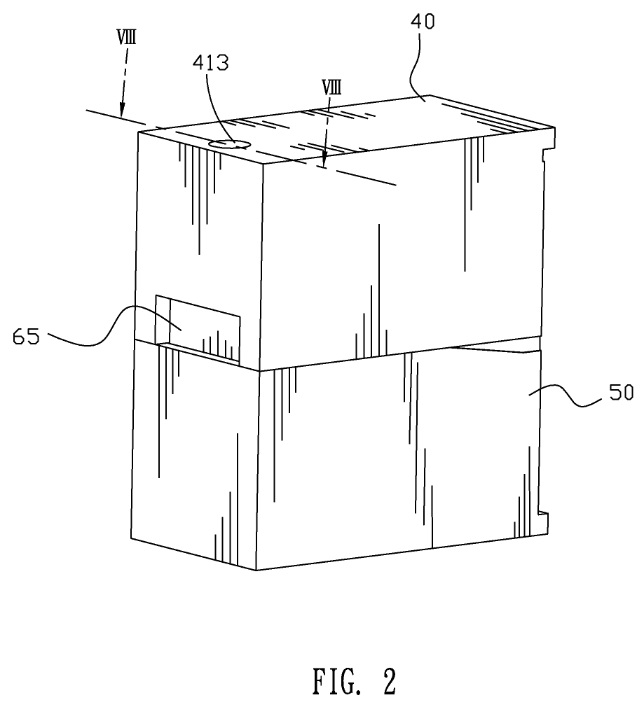

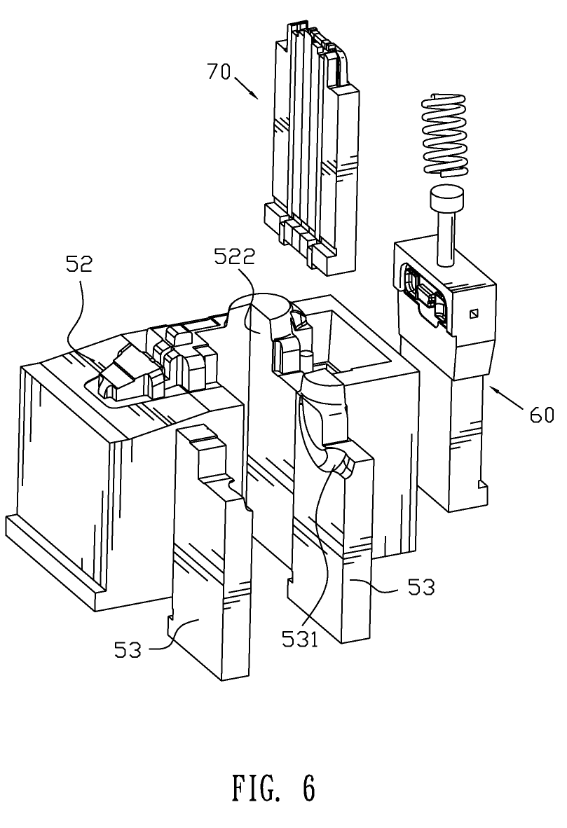

First referring to FIGS. 1 and 2, an injection mold 1 according to the invention is shown. The injection mold 1 comprises a stationary plate 10, a movable plate 20 and four mold units 30. The mold unit 30 is composed of a movable mold section 50, a stationary mold section 40 and a sliding apparatus 60 (shown in FIG. 6) received between the movable mold section 50 and the stationary mold section 40. The stationary plate 10 has four upper receiving rooms 101 to receive the four stationary mold sections 40 respectively. An injecting hole 102 is opened in a middle of the stationary plate 10 to guide liquefied molding material (e.g., plastic) under pressure into a molding cavity defined between the stationary mold section 40 and the movable mold section 50, thermal energy is emitted so that the liquefied molding material cools to form a solid within the molding cavity. The movable plate 20 has four lower receiving rooms 201 to receive the movable mold sections 50 respectively. A fluid channel 202 formed in an upper surface of the movable plate 20 connects the movable mold sections 50 to conduct liquefied molding material into the molding cavity. And the sliding apparatus 60 is received between the stationary mold section 40 and the movable mold section 50 to remove an article molded in the mold unit 30.

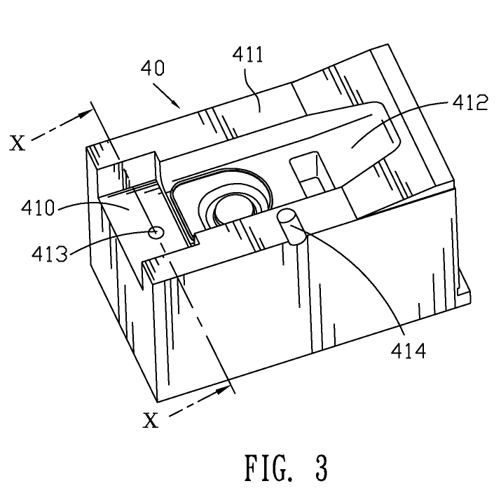

Please refer to FIG. 3, the stationary mold section 40 shows a cuboid shape. An upper end of the stationary mold section 40 has a contacting surface 411. The contacting surface 411 dents to form a containing cavity 412 and an upper receiving cavity 410. An end of the containing cavity 412 connects to the upper receiving cavity 410. A middle of the upper receiving cavity 410 defines a fixing hole 413 which passes through the stationary mold section 40 from top to bottom. An upper injecting channel 414 is arranged in the contacting surface 411 and located at a side of the containing cavity 412. The shape of a bottom of the containing cavity 412 can be changed according to a shape of a product which is formed in the mold unit 30.

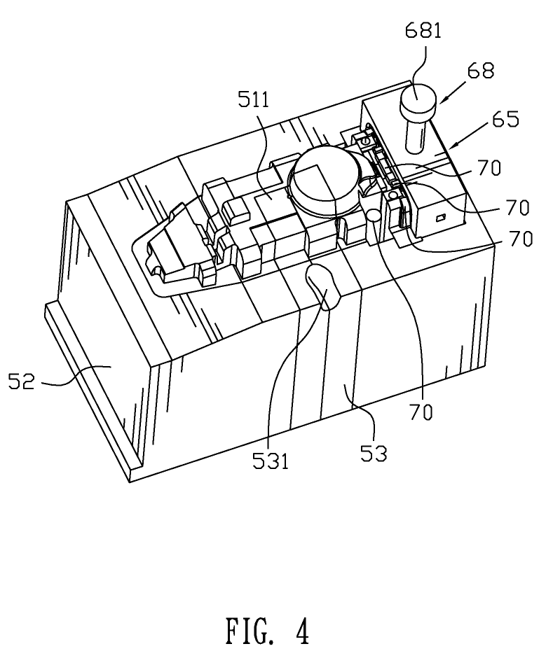

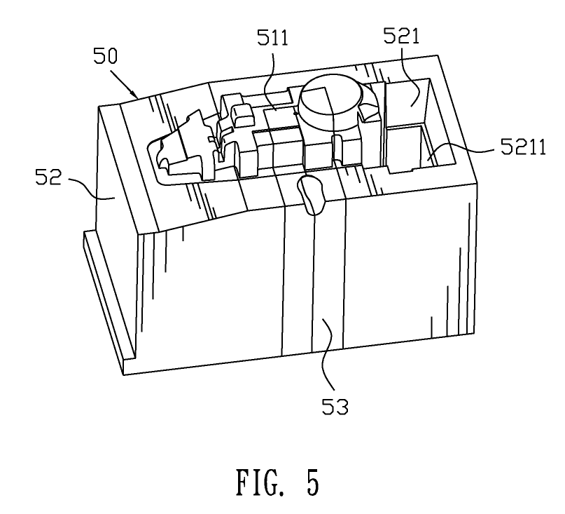

Referring to FIGS. 4-6, the movable mold section 50 includes a central body 52 and two inserting elements 53. An inserting groove 522 is defined in a side of the central body 52 to receive the two inserting elements 53. Two top surfaces of the two inserting elements 53 and a top surface of the central body 52 define a shaping convex 511. The two inserting elements 53 have a lower injecting channel 531 respectively, the lower injecting channels 531 match with the upper injecting channel 414 to form an injecting channel to conduct liquefied molding material into the molding cavity. When the movable mold section 50 and the stationary mold section 40 are assembled together, the shaping convex 511 is located in the containing cavity 412, the molding cavity is defined between the shaping convex 511 and the containing cavity 412. A front portion of the central body 52 defines a lower receiving cavity 521, three sides of the lower receiving cavity 521 project inward to form a holding lump 5211.

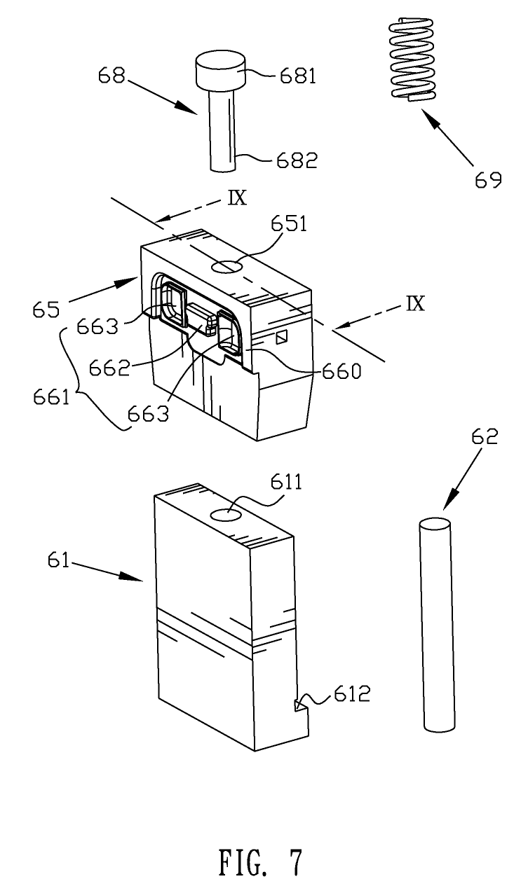

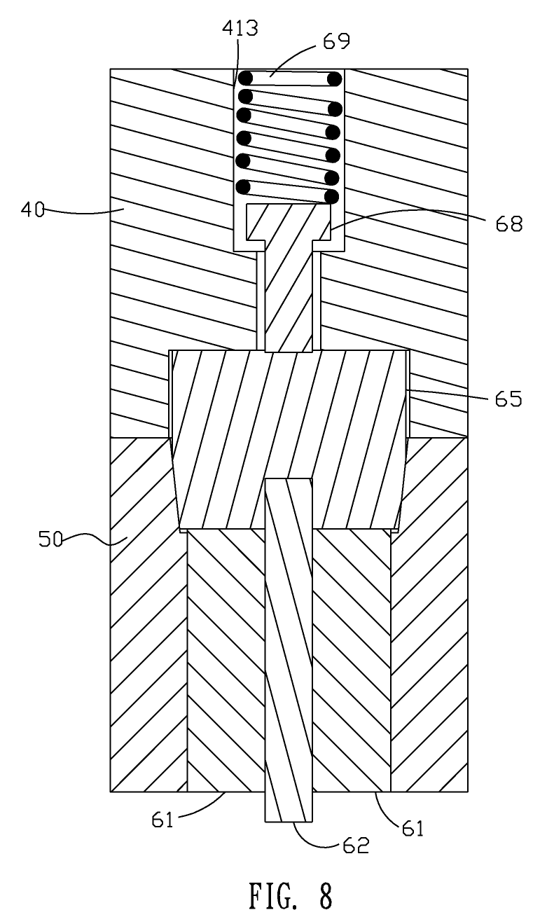

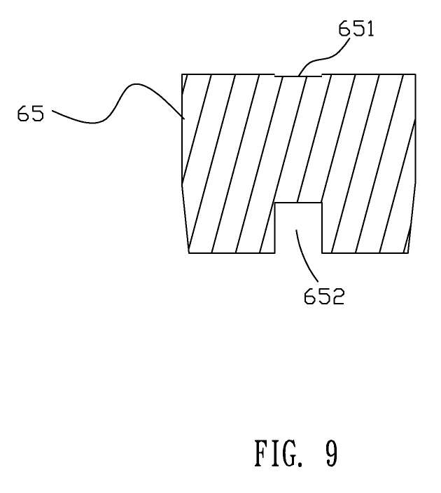

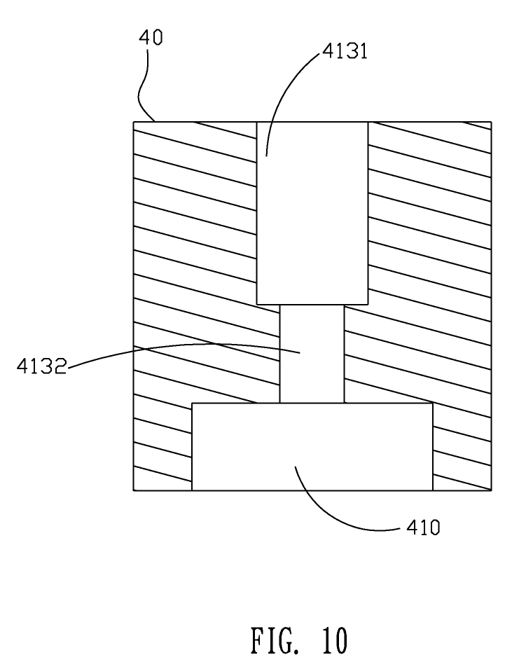

Referring to FIGS. 7-10, the sliding apparatus 60 includes a fixing component 61, an ejecting rod 62, an up-down sliding side core 65, a pushing bar 68 and an elastic element 69. In this embodiment, the elastic element 69 is a spring. The pushing bar 68 and the elastic element 69 are received in the fixing hole 413, and the elastic element 69 is located above the pushing bar 68. The pushing bar 68 has a limiting cap 681 and a pushing portion 682 extended from a bottom surface of the limiting cap 681. A diameter of the limiting cap 681 is larger than a diameter of the pushing portion 682. An upper surface of the sliding side core 65 defines an auxiliary cavity 651 to receive a bottom end of the pushing portion 682, a lower surface of the sliding side core 65 defines a recess 652, a side of the sliding side core 65 adjacent to the molding cavity has a fixing surface 660, a knaggy portion 661 is defined in the fixing surface 660 and the molding cavity. The knaggy portion 661 is a concave cavity or a projection, may be a coalition of a concave cavity and a projection. A shape of the knaggy portion 661 matches with a side of an article formed in the molding cavity. In this embodiment, the knaggy portion 661 includes two concave cavities 663 and a projection 662 extended into the molding cavity, and the two concave cavities 663 are located at two sides of the projection 662. The fixing component 61 received in a lower portion of the lower receiving cavity 521 has a penetrating hole 611 which passes through the fixing component 61 from top to bottom. A bottom portion of the fixing component 61 projects forward to form a resisting portion 612. The ejecting rod 62 is received in the penetrating hole 611.

The fixing hole 413 formed in the stationary mold section 40 is composed of a first receiving hole 4131 and a second receiving hole 4132 beneath the first receiving hole 4131. The second receiving hole 4132 connects with the upper receiving cavity 410. A diameter of the first receiving hole 4131 is larger than a diameter of the second receiving hole 4132, a step is defined between the first and the second receiving holes 4131, 4132. The limiting cap 681 of the pushing bar 68 is received in a lower portion of the first receiving hole 4131 and limited by the step, the elastic element 69 is received in the first receiving hole 4131 and located on the limiting cap 681, the pushing portion 682 is received in the second receiving hole 4132 so as to push the sliding side core 65 downward when the stationary and the movable mold sections 50, 40 are closed.

When the sliding apparatus 60 is received in the stationary mold section 40 and the movable mold section 50, an upper portion of the sliding side core 65 is received in the upper receiving cavity 410 of the stationary mold section 40, a lower portion of the sliding side core 65 is received in an upper portion of the lower receiving cavity 521, and the bottom of the sliding side core 65 resists the holding lump 5211. The pushing bar 68 is received in the fixing hole 413, the elastic element 69 is received in the first receiving hole 4131 and presses down the pushing bar 68, the limiting cap 681 has a small distance with the step formed between the first receiving hole 4131 and the second receiving hole 4132, and a bottom end of the pushing portion 682 is located in the auxiliary cavity 651. The fixing component 61 is received in a bottom of the lower receiving cavity 521, a top surface of the fixing component 61 resists a bottom surface of the sliding side core 65. The ejecting rod 62 passes through the penetrating hole 611, and an upper end of the ejecting rod 62 is received in the recess 652 and resists a top surface of the recess 652. A plurality of inserting apparatuses 70 are received in the lower receiving cavity 521 and located between the sliding side core 65 and the shaping convex 511.

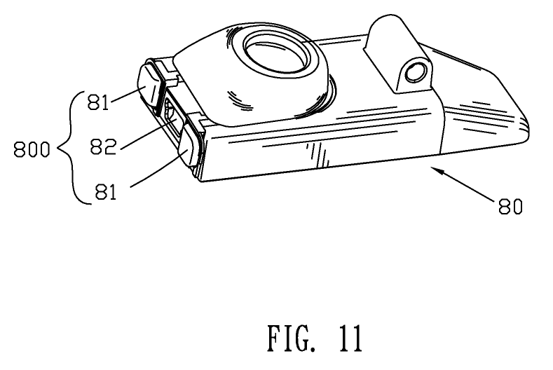

Referring to FIG. 11, the injection mold 1 is used to form an article 80 by once molding. A rear side of the article 80 is a knaggy side surface 800 which is composed of an inserting hole 82 and two projections 81 located at two sides of the inserting hole 82. The shapes of the inserting hole 82 and the projections 81 are defined by the projection 662 and the two concave cavities 663 respectively. When the stationary mold section 40 and the movable mold section 50 are close together, the liquefied molding material into the molding cavity to form the article 80, the knaggy portion 661 of the sliding side core 65 is covered by the liquefied molding material to form the knaggy side surface 800 of the article 80, and then the stationary mold section 40 separates with the movable mold section 50, the ejecting rod 62 pushes upward the sliding side core 65, so the sliding side core 65 brings the article 80 out of the molding cavity because the knaggy portion 661 matching with the knaggy side surface 800.

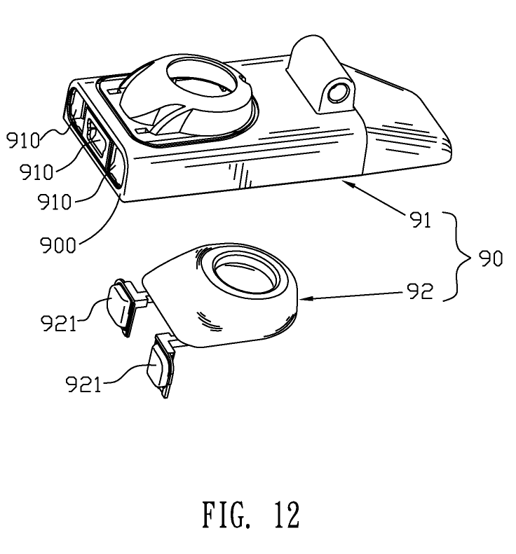

In FIG. 12, a whole article 90 is composed of a first article 91 and a second article 92. A rear side of the first article 91 is a knaggy side surface 900 which concaves inward to form three concave holes 910. The shape of the concave hole 910 in middle matches with that of the projection 662. After the concave hole 910 in middle matches with the projection 662, the sliding side core 65 is moved into the lower receiving cavity 521 and moves the first article 91 into the molding cavity. When the mold unit 30 is closed, the liquefied molding material is injected to the molding cavity to form the second article 92 which is integrated with the first article 91. As second molding, the second article 92 is molded in the mold unit 30 when the first article 91 is arranged into the molding cavity by the sliding side core 65 or another method, the second article 92 has two contacting pieces 921 corresponding to two concave holes 910 which are formed two sides of the first article 91 and extending out from the two concave holes 910.

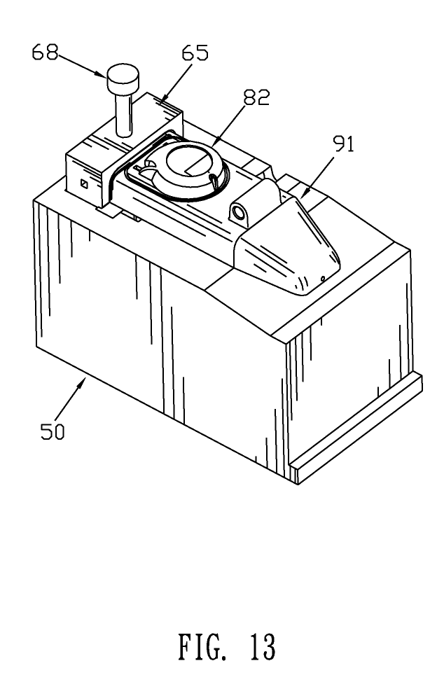

Please referring to FIGS. 12 and 13, when the stationary mold section 40 and the movable mold section 50 are closed together, the first article 91 is arranged in the molding cavity of the mold unit 30 in advance, then liquefied molding material is injected into the molding cavity via the upper injecting channel 414 and the lower injecting channels 531 to form the second article 92, the two contacting pieces 921 are molded in the concave cavities 663, the projection 662 is located in the concave hole 910 in middle.

When the mold unit 30 is opened, the stationary mold section 40 is dragged upward to separate with the movable mold section 50. The pushing portion 682 of the pushing bar 68 pushes downward the sliding side core 65 to separate from the stationary mold section 40 by the elastic element 69 pushing downward the pushing bar 68 until the limiting cap 681 is against the junction of the first receiving hole 4131 and the second receiving hole 4132 and pushed upward. After the stationary mold section 40 and the movable mold section 50 are separated, the ejecting rod 62 is pushed upward along the penetrating hole 611, and the ejecting rod 62 pushes upward the sliding side core 65, the sliding side core 65 is removed upward by the ejecting rod 62 pushing bar. Because the rear side of the whole article 90 connects to the knaggy portion 661, so the whole article 90 is removed out from the molding cavity together with the sliding side core 65.

The mold unit 30 may be composed of three or more inserts according to a practice manufacture and the structure of the article 80. The mold unit 30 can be used to manufacture a once-shaping product. In order to remove the sliding side core 65 steadily, a contacting area between the pushing bar 68 and the sliding side core 65 and between the fixing component 61 and the pushing bar 68 is enlarged, and a quantity of the pushing bar 68 and the fixing component 61 is not limited to one. The knaggy portion 661 of the sliding side core 65 can be changed with different shape of an article.

As description above, the injection mold 1 is capable of molding an expected product and conveniently guide the plastic product out of the mold by the sliding side core 65. And the sliding side core 65 is easy to manufacture, the cost of manufacturing the injection mold 1 is lower.

An embodiment of the present invention has been discussed in detail. However, this embodiment is merely a specific example for clarifying the technical contents of the present invention and the present invention is not to be construed in a restricted sense as limited to this specific example. Thus, the spirit and scope of the present invention are limited only by the appended claims.

What is claimed is:

1. An injection mold adapted for forming an article with a knaggy side surface, comprising:
a stationary mold section;
a movable mold section placed under the stationary mold section, the stationary and the movable mold sections defining a molding cavity therebetween for forming the article;
an up-down sliding side core defining a knaggy portion in a side surface thereof, the sliding side core being slidably received between the stationary mold section and the movable mold section with the knaggy portion connecting to the molding cavity for forming the knaggy side surface of the article; and
an ejecting rod having an upper end secured to the sliding side core and a lower end extending downwardly through the movable mold and protruding from the movable mold for being urged upward to push the sliding side core together with the article out of the molding cavity.

2. The injection mold as set forth in claim 1, wherein the movable mold section defines a lower receiving cavity for slidably receiving the sliding side core therein.

3. The injection mold as set forth in claim 1, wherein a bottom surface of the sliding side core defines a recess for engaging the upper end of the ejecting rod.

4. The injection mold as set forth in claim 1, further comprising a fixing component which is fixed in the movable mold section and beneath the sliding side core, the ejecting rod passing through the fixing component to resist the sliding side core.

5. The injection mold as set forth in claim 2, further comprising a pushing bar received in the stationary mold section and an elastic element disposed on the pushing bar for urging the pushing bar downward to push the sliding side core to return into the movable mold section.

6. The injection mold as set forth in claim 5, wherein the pushing bar has a pushing portion and a limiting cap wider than the pushing portion, the stationary mold section defines a first receiving hole and a second receiving hole connecting with the first receiving hole and having a smaller dimension than the first receiving hole to define a step therebetween, the limiting cap is received in the first receiving hole and limited in the first receiving hole by the step, the elastic element is also received in the first receiving hole and disposed on the limiting cap, the pushing portion is received in the second receiving hole so as to push the sliding side core downward when the stationary and the movable mold sections are closed.

7. The injection mold as set forth in claim 6, wherein the elastic element is a spring.

8. The injection mold as set forth in claim 6, wherein the stationary mold section defines an upper receiving cavity connecting to the second receiving hole for matching with the lower receiving cavity to receive the sliding side core therebetween.

9. The injection mold as set forth in claim 1, further comprising an inserting apparatus received in the lower receiving cavity.

10. An injection mold adapted for receiving an article with a knaggy side surface for second molding, comprising:
a stationary mold section;
a movable mold section placed under the stationary mold section, the stationary and the movable mold sections defining a molding cavity therebetween;
an up-down sliding side core slidably received between the stationary mold section and the movable mold section, the sliding side core defining a knaggy portion in a side surface thereof for receiving the knaggy side surface of the article; and
an ejecting rod having an upper end secured to the sliding side core and a lower end extending downwardly through the movable mold and protruding from the movable mold for being urged upward to push the sliding side core out of the movable mold section, whereby the sliding side core can be ejected to receive the knaggy side surface of the article first and then bring the article into the molding cavity for second molding.

11. The injection mold as set forth in claim 10, wherein the movable mold section defines a lower receiving cavity for slidably receiving the sliding side core therein.

12. The injection mold as set forth in claim 10, wherein a bottom surface of the sliding side core defines a recess for engaging the upper end of the ejecting rod.

13. The injection mold as set forth in claim 10, further comprising a fixing component which is fixed in the movable mold section and beneath the sliding side core, the ejecting rod passing through the fixing component to resist the sliding side core.

14. The injection mold as set forth in claim 11, further comprising a pushing bar received in the stationary mold section and an elastic element disposed on the pushing bar for urging the pushing bar downward to push the sliding side core to return into the movable mold section.

15. The injection mold as set forth in claim 14, wherein the pushing bar has a pushing portion and a limiting cap wider than the pushing portion, the stationary mold section defines a first receiving hole and a second receiving hole connecting with the first receiving hole and having a smaller dimension than the first receiving hole to define a step therebetween, the limiting cap is received in the first receiving hole and limited in the first receiving hole by the step, the elastic element is also received in the first receiving hole and disposed on the limiting cap, the pushing portion is received in the second receiving hole so as to push the sliding side core downward when the stationary and the movable mold sections are closed.

16. The injection mold as set forth in claim 15, wherein the elastic element is a spring.

17. The injection mold as set forth in claim 15, wherein the stationary mold section defines an upper receiving cavity connecting to the second receiving hole for matching with the lower receiving cavity to receive the sliding side core therebetween.

18. The injection mold as set forth in claim 10, further comprising an inserting apparatus received in the lower receiving cavity.
